(19) United States
(12) Patent Application Publication
(10) Pub. No.: US 2025/0304035 A1
(43) Pub. Date: Oct. 2, 2025

(54) Method and Device for Controlling Traveling of Vehicle, Controller, Vehicle, and Program Product

(71) Applicant: Robert Bosch GmbH, Stuttgart (DE)

(72) Inventors: Na Yang, Suzhou (CN); Shaobo Liu, Suzhou (CN); Jianjun Wang, Suzhou (CN)

(21) Appl. No.: 19/088,059

(22) Filed: Mar. 24, 2025

(30) Foreign Application Priority Data
Mar. 29, 2024 (CN) 2024 1038 1127.6

(51) Int. Cl. B60W 30/045

(52) U.S. Cl. CPC B60W 30/045; B60W 2520/00; B60W 2520/10; B60W 2552/30

(57) ABSTRACT

A method and a device for controlling traveling of a vehicle on a bend, a controller, a vehicle, and a computer program product are disclosed. The method includes (i) obtaining road information of the bend in response to detecting that the vehicle is located on the bend, (ii) obtaining vehicle traveling information for the bend, the vehicle traveling information comprising current traveling information and historical traveling information, and (iii) controlling traveling of the vehicle on the bend through the road information and the vehicle traveling information. The method is capable of controlling traveling of the vehicle on the bend according to the current traveling information and the historical traveling information of the vehicle, thereby improving the controlling consistency of traveling of the vehicle on the bend and making the traveling of the vehicle more consistent with user habits, so as to improve user experience.

This application claims priority under 35 U.S.C. § 119 to application no. CN 2024 1038 1127.6, filed on Mar. 29, 2024 in China, the disclosure of which is incorporated herein by reference in its entirety.

Embodiments of the present disclosure relate to the field of controlling of vehicles, in particular to a method and a device for controlling traveling of a vehicle on a bend, a controller, a vehicle, and a computer program product.

### BACKGROUND

With the development of technology, controlling of vehicles has become more intelligent. An increasing number of vehicles have predetermined traveling control functions such as assisted driving or autonomous driving, etc. In case that this predetermined traveling control function is enabled, the vehicle may be maintained on a current lane to travel based on a current real-time detected road environment. Typically, this predetermined traveling control function causes the vehicle to travel along a predetermined route in the lane in order to ensure safety of the vehicle. In particular, when the vehicle is on a road with a high hazard coefficient, such as a bend, the vehicle is strictly controlled to travel along a predetermined turn route (e.g., center line) in the road.

However, differences in vehicle manufacturing or different degrees of aging in the course of use of the vehicle may result in control modules of different vehicles or control modules of the same vehicle to occur various deviations in actual control results within different periods of time if the vehicle is controlled according to the predetermined turn route.

### SUMMARY

Embodiments of the present disclosure provide a method and a device for controlling traveling of a vehicle on a bend, a controller, a vehicle, and a computer program product.

According to a first aspect of the present disclosure, a method for controlling traveling of a vehicle on a bend is provided. The method comprises: obtaining road information of the bend in response to detecting that the vehicle is located on the bend. The method further comprises: obtaining vehicle traveling information for the bend, the vehicle traveling information comprising current traveling information and historical traveling information. The method further comprises: controlling traveling of the vehicle on the bend through the road information and the vehicle traveling information.

According to a second aspect of the present disclosure, a device for controlling traveling of a vehicle on a bend is provided. The device comprises a road information obtaining unit configured to obtain road information of the bend in response to detecting that the vehicle is located on the bend. The device also comprises a vehicle traveling information obtaining unit configured to obtain vehicle traveling information for the bend, the vehicle traveling information comprising current traveling information and historical traveling information. The device also comprises a turn control unit configured to control traveling of the vehicle on the bend through road information and vehicle traveling information.

According to a third aspect of the present disclosure, a controller is provided. The controller comprises at least one processor; and a memory coupled to the at least one processor and having instructions stored thereon that, when executed by the at least one processor, cause the controller to implement the method according to the first aspect of the present disclosure.

According to a fourth aspect of the present disclosure, a vehicle is provided. The vehicle comprises a controller according to the third aspect of the present disclosure.

According to a fifth aspect of the present disclosure, a computer program product is provided. The computer program product has computer-executable instructions stored thereon, wherein the computer-executable instructions are executed by a processor to implement the method according to the first aspect of the present disclosure.

According to a sixth aspect of the present disclosure, a computer-readable storage medium is provided. The computer-readable storage medium has computer-executable instructions stored thereon, wherein the computer-executable instructions are executed by a processor to implement the method according to the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1A to FIG. 1C illustrate schematic diagrams of an exemplary environment in which a device and/or a method according to an example of the present disclosure may be implemented.

FIG. 2 illustrates a flow chart of a method for controlling traveling of a vehicle on a bend according to an example of the present disclosure.

FIG. 3 illustrates a flow chart of a process for controlling traveling of a vehicle on a bend through road information and vehicle traveling information according to an example of the present disclosure.

FIG. 4 illustrates a flow chart of a process for controlling traveling of a vehicle on a bend by using a customary wheel end rotation angle in FIG. 3 according to an example of the present disclosure.

FIG. 5 illustrates a flow chart of a process for determining a compensation wheel end rotation angle in FIG. 4 according to an example of the present disclosure.

FIG. 6 illustrates a flow chart of a process for determining a compensation wheel end rotation angle in FIG. 4 according to another example of the present disclosure.

FIG. 7 illustrates a schematic block diagram of an example control module for controlling traveling of a vehicle on a bend in the vehicle according to an example of the present disclosure.

FIG. 8 illustrates a schematic block diagram of a device for controlling traveling of a vehicle on a bend according to an example of the present disclosure.

FIG. 9 illustrates a schematic block diagram of one example of an exemplary device according to one example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first” “second”, etc. may refer to and represent different or the same object. Other explicit and implicit definitions may be included below.

With the development of technology, controlling of vehicles has become more intelligent. An increasing number of vehicles have predetermined traveling control functions such as assisted driving or autonomous driving, etc. In case that this predetermined traveling control function is enabled, the vehicle may be maintained on a current lane to travel based on a current real-time detected road environment. Typically, this predetermined traveling control function causes the vehicle to travel along a predetermined route in the lane in order to ensure safety of the vehicle. In particular, when the vehicle is on a road with a high hazard coefficient, such as a bend, the vehicle is strictly controlled to travel along a predetermined turn route (e.g., center line) in the road.

However, differences in vehicle manufacturing or different degrees of aging in the course of use of the vehicle may result in control modules of different vehicles or control modules of the same vehicle to occur various deviations in actual control results within different periods of time if the vehicle is controlled according to the predetermined turn route. Further, users (e.g., drivers) may have different driving habits when manually driving a vehicle, e.g., some users may be accustomed to traveling on one side of a predetermined route (e.g., center line) above, while others may be accustomed to traveling on the other side of the predetermined route above. In particular, in case of traveling on the bend with the hazard coefficient, the users may be more accustomed to maintaining their individual driving habits for higher traveling comfort and safety. As a result, the predetermined traveling control function described above may not adapt to user's driving habits, resulting in poor user experience.

To address at least the above and other potential problems, the examples of the present disclosure provide a method for controlling traveling of a vehicle on a bend. The method comprises: obtaining road information of the bend in response to detecting that the vehicle is located on the bend. The method further comprises: obtaining vehicle traveling information for the bend, the vehicle traveling information comprising current traveling information and historical traveling information. The method further comprises: controlling traveling of the vehicle on the bend through the road information and the vehicle traveling information. The method according to the examples of the present disclosure is capable of controlling traveling of the vehicle on the bend according to the current traveling information and the historical traveling information of the vehicle, thereby improving the controlling consistency of traveling of the vehicle on the bend and making the traveling of the vehicle more consistent with user habits, so as to improve user experience.

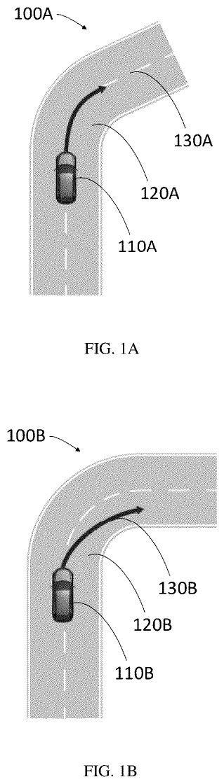

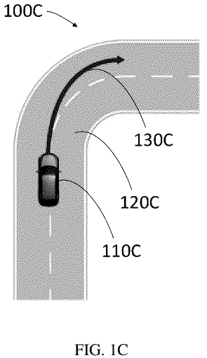

Below, examples of the present disclosure will be described in detail with reference to the accompanying drawings. FIG. 1A to FIG. 1C illustrate schematic diagrams of an exemplary environment in which a device and/or a method according to an example of the present disclosure may be implemented. FIG. 1A illustrates a schematic vehicle traveling environment 100A for a predetermined traveling control function (e.g., an assisted driving function or an autonomous driving function) of the vehicle. As shown in the environment 100A of FIG. 1A, in case that the predetermined traveling control function of the vehicle 110A is enabled, the vehicle 110A may both be maintained to travel along a predetermined turn route 130A of the bend 120A for any traveling speed and any radius of curvature. The predetermined turn route 130A is shown in FIG. 1A as a center line of the bend 120A, and it should be understood that the predetermined turn route 130A may also be other predetermined routes that deviate from the center line.

FIG. 1B illustrates a schematic vehicle traveling environment 100B for manual driving by a user. As shown in the environment 100B of FIG. 1B, a user of the vehicle 110B may be accustomed to traveling the vehicle 110B along a traveling route 130B that is offset to the right from the center line of the bend 120B for the bend with a particular traveling speed and a particular radius of curvature (e.g., 80 km/h and 300 m).

FIG. 1C illustrates another schematic vehicle traveling environment 1000 for manual driving by a user. As shown in the environment 100C of FIG. 1C, a user of the vehicle 110C may be accustomed to traveling the vehicle 110C along a traveling route 130C that is offset to the left from the center line of the bend 120C for the bend with a particular traveling speed and a particular radius of curvature (e.g., 80 km/h and 300 m).

Further, while FIG. 1B and FIG. 1C show that some users are accustomed to traveling along traveling routes 130B and 130C that deviate from the center line, some other users may also be accustomed to causing the vehicle to travel along the center line of the bend, in which case the schematic vehicle traveling environment 100A of FIG. 1A may also be used for indicating manual driving habits for such users.

Further, it should be understood that the same user may also have different driving habits during traveling on the bend with different radii of curvature at different speeds. For example, the user may be accustomed to traveling on one side of the center line of the bend at some of the radii of curvature during traveling on the bend at some of the speeds, and the user may be accustomed to traveling on the other side of the center line of the bend at some of the other radii of curvature during traveling on the bend and the other speeds.

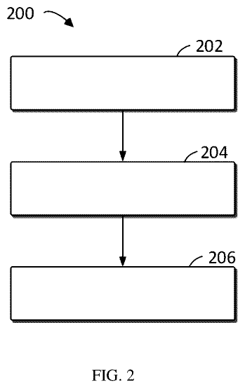

Embodiments according to the present disclosure enable the vehicle to travel consistently on the bend according to the user's individual driving habits in case that the predetermined driving function of the vehicle is enabled, thereby giving the user traveling experience similar to manual traveling, and greatly increasing the user's comfort and sense of safety. FIG. 2 illustrates a flow chart of a method 200 for controlling traveling of a vehicle on a bend according to an example of the present disclosure. The method 200 may be applied to any traveling environment shown in FIG. 1B to FIG. 1C (and FIG. 1A (when it is used for indicating manual driving habits for a user)), and the method 200 may be performed by any controller, electronic device, or server.

As shown in FIG. 2, at block 202, road information of the bend is obtained in response to detecting that the vehicle is located on the bend. In some examples, block 202 may also be performed in response to enabling of the predetermined traveling control function of the vehicle (e.g., assisted driving or autonomous driving). In some examples, the road information may comprise a radius of curvature (e.g., 300 meters, or 700 meters or any other value) of the bend on which the vehicle is located. In some examples, the radius of curvature of the bend may be detected by a detection unit of the vehicle (e.g., a camera or other sensors).

At block 204, vehicle traveling information for the bend is obtained. In some examples, the vehicle traveling information may comprise current traveling information and historical traveling information. In some examples, the current traveling information may comprise a current speed of the vehicle (e.g., 80 km/h, or 60 km/h or any other values). In some examples, the current traveling information may comprise a theoretical turn angle for the current speed and the radius of curvature (e.g., 80 km/h and 300 m). In some examples, the theoretical turn angle may correspond to a theoretical wheel end rotation angle (e.g., 1 degree) for traveling a vehicle along a predetermined turn route (e.g., the center line of the bend) in case that the predetermined traveling control function is enabled.

In some examples, the historical traveling information may comprise a customary turn angle for the current speed and the radius of curvature (e.g., 80 km/h and 300 m). In some examples, the customary turn angle may correspond to a customary wheel end rotation angle (e.g., 1.2 degrees) of the vehicle in case that the predetermined traveling control function is not enabled (e.g., in the case of manual driving by the user). In some examples, the historical traveling information may be stored in a predetermined memory as a mapping table indicating a mapping relationship between “speed, radius of curvature, and customary wheel end rotation angle.” In this instance, the mapping table may be retrieved according to the radius of curvature and the current speed at block 204 to obtain a corresponding customary wheel end rotation angle.

Further, in order to obtain the customary wheel end rotation angle to be stored in the above-described mapping table, in some examples, the method 200 according to the present disclosure may further comprise: obtaining the customary wheel end rotation angle through all historical wheel end rotation angles. In some examples, the historical wheel end rotation angle may represent the wheel end rotation angle of the vehicle traveling on the bend with the current radius of curvature at a current speed in case that the predetermined traveling control function is not enabled prior to current time. For example, the customary wheel end rotation angle can be obtained by averaging all historical wheel end rotation angles. In this way, the obtained customary wheel end rotation angles can be made to reflect the user's overall driving habits.

In some other examples, the method 200 according to the present disclosure may further comprise: obtaining the customary wheel end rotation angle through a most recent predetermined number of historical wheel end rotation angles. For example, the customary wheel end rotation angle can be obtained by averaging the most recent 10 historical wheel end rotation angles. In this way, the obtained customary wheel end rotation angle may be made to reflect the user's most recent driving habits.

In yet other examples, the method 200 according to the present disclosure may further comprise: obtaining the customary wheel end rotation angle through historical wheel end rotation angles within a most recent predetermined period of time. For example, the customary wheel end rotation angle can be obtained by averaging the historical wheel end rotation angle within the most recent one month. In this way, the obtained customary wheel end rotation angle may also be able to reflect the user's most recent driving habits.

In the above manner, it is convenient and easy to obtain the customary wheel end rotation angle without the need for complex computing, so only a small number of computing resources is required. It should be understood that the specific number of times, specific period of time, and modes for averaging shown in various examples above are only examples. In practical applications, any other number of times, periods of time, and other modes for obtaining the customary wheel end rotation angle may be set according to needs.

At block 206, traveling of the vehicle on the bend is controlled by road information and vehicle traveling information. Because controlling of traveling of the vehicle on the bend utilizes the historical traveling information in the vehicle traveling information, and the vehicle traveling information corresponds to a user's customary wheel end rotation angle (i.e., driving habit) as described above, the controlling enables the vehicle to be consistently controlled by tracking the user's driving habits even if the vehicle has different manufacturing differences or different degrees of aging over time. Thus, the method according to the examples of the present disclosure is capable of controlling traveling of the vehicle on the bend according to the current traveling information and the historical traveling information of the vehicle, thereby improving the controlling consistency of traveling of the vehicle on the bend and making the traveling of the vehicle more consistent with user habits, so as to improve user experience.

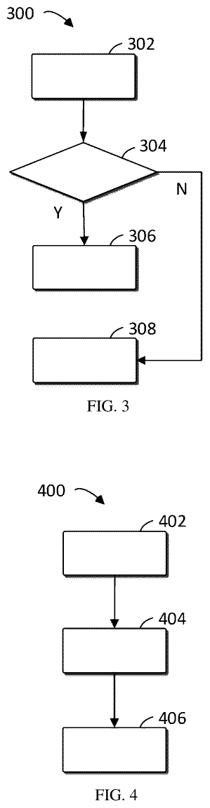

The method 200 according to the present disclosure is described further below in connection with FIG. 2 to FIG. 5. FIG. 3 illustrates a flow chart of a process 300 for controlling traveling of a vehicle on a bend through road information and vehicle traveling information according to an example of the present disclosure. The process of FIG. 3 corresponds to block 206 in FIG. 2. As shown in FIG. 3, at block 302, a wheel end rotation angle difference between the customary wheel end rotation angle and the theoretical wheel end rotation angle obtained at block 204 of FIG. 2 may be determined. At block 304, it may be determined whether the wheel end rotation angle difference determined at block 302 is less than or equal to a predetermined threshold. For example, the predetermined threshold may be a safety threshold for the difference between the user's customary wheel end rotation angle and the theoretical wheel end rotation angle. In some examples, the predetermined threshold may be in the form of a percentage (e.g., 20% or any other value) or any other form, and may be a system default, a user specified value, or an empirical value, etc.

In case that the wheel end rotation angle difference is determined to be less than or equal to a predetermined threshold at block 304 (“Y” in FIG. 3), at block 306, the customary wheel end rotation angle (e.g., 1.2 degrees in the above example) may be used to control traveling of the vehicle on the bend (described further in the following example). Here, the wheel end rotation angle difference being less than or equal to the predetermined threshold may indicate that it is safe to control the vehicle according to the user's driving habits, and therefore, the customary wheel end rotation angle may be used for controlling the traveling of the vehicle on the bend.

In case that the wheel end rotation angle difference is determined to be greater than the predetermined threshold at block 304 (“N” in FIG. 3), at block 308, the theoretical wheel end rotation angle (e.g., 1 degree in the above example) may be used for controlling traveling of the vehicle on the bend. Here, the wheel end rotation angle difference being greater than the predetermined threshold may indicate that controlling the vehicle according to the user's driving habits may not be safe, so the customary wheel end rotation angle may not be used, but the theoretical wheel end rotation angle may be used for controlling traveling of the vehicle on the bend. By using the process 300 as shown in FIG. 3, the safety of the user's actual driving habits can be judged, thereby further ensuring the safety of the vehicle.

FIG. 4 illustrates a flow chart of a process 400 for controlling traveling of a vehicle on a bend by using a customary wheel end rotation angle in FIG. 3 according to an example of the present disclosure. The process 400 shown in FIG. 4 corresponds to block 306 shown in FIG. 3. As shown in FIG. 4, at block 402, the wheel end rotation angle of the vehicle may be adjusted to the customary wheel end rotation angle (e.g., 1.2 degrees). At block 404, the compensation wheel end rotation angle may be determined through the current position and the current orientation of the vehicle during traveling of the vehicle. In some examples, the compensation wheel end rotation angle may be used for correcting a traveling error of the vehicle during traveling. For example, the camera and other sensors of the vehicle may be used for detecting a current position of the vehicle (e.g., a transverse distance from a tracked route) and a current orientation (e.g., an angle to the tracked route) relative to the tracked route in the bend for determining the compensation wheel end rotation angle.

At block 406, the current wheel end rotation angle of the vehicle may be adjusted through the compensation wheel end rotation angle to control traveling of the vehicle on the bend. Here, as a traveling error may occur during traveling of the vehicle, adjusting the current wheel end rotation angle of the vehicle through the compensation wheel end rotation angle may allow the vehicle to be controlled more accurately during traveling of the vehicle, thereby improving the consistency of control of the vehicle and improving the user experience.

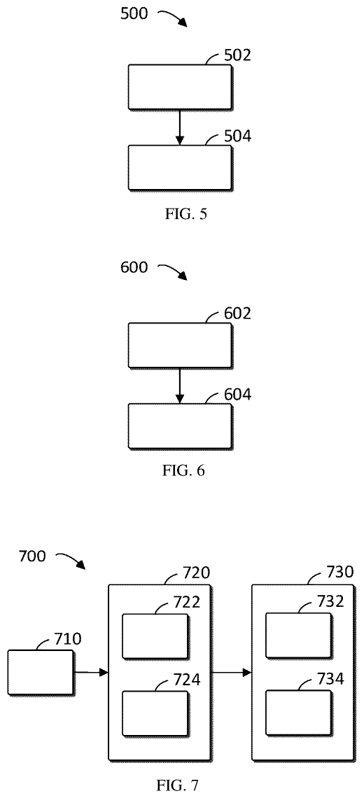

FIG. 5 illustrates a flow chart of a process 500 for determining a compensation wheel end rotation angle in FIG. 4 according to an example of the present disclosure. The process 500 of FIG. 5 corresponds to block 404 of FIG. 4. As shown in FIG. 5, at block 502, a first compensation wheel end rotation angle for adjusting the vehicle to a predetermined turn route (e.g., the center line of the bend) may be determined by the current position and the current orientation of the vehicle.

At block 504, the first compensation wheel end rotation angle may be adjusted by the wheel end rotation angle difference to obtain the second compensation wheel end rotation angle. In some examples, a second compensation wheel end rotation angle can be obtained, for example, by subtracting the wheel end rotation angle difference from the first compensation wheel end rotation angle. It should be understood that this is only an example, and the first compensation wheel end rotation angle can be adjusted through the wheel end rotation angle difference in any other modes according to actual needs. In the case shown in FIG. 5, in some examples, the current wheel end rotation angle of the vehicle may be adjusted at block 406 of FIG. 4 through the second compensation wheel end rotation angle obtained at block 504.

FIG. 6 illustrates a flow chart of a process for determining a compensation wheel end rotation angle in FIG. 4 according to another example of the present disclosure. The process 600 of FIG. 6 corresponds to block 404 of FIG. 4. As shown in FIG. 6, at block 602, the actual turn route (e.g., the actual turn routes 130B and 130C shown in FIG. 1B and FIG. 1C) of traveling of the vehicle on the bend can be determined by the radius of curvature of the bend, the current speed of the vehicle, and the customary wheel end rotation angle described above. At block 604, a third compensation wheel end rotation angle for adjusting the vehicle to the actual turn route may be determined by the current position and the current orientation of the vehicle. In some examples, at block 604, the third compensation wheel end rotation angle for adjusting the vehicle to the actual turn route may be determined through the current position of the vehicle, the current orientation of the vehicle, and vehicle parameters by using the Ackerman angle geometry and steering characteristics of the vehicle at block 502. In the case shown in FIG. 6, in some examples, the current wheel end rotation angle of the vehicle may be adjusted at block 406 of FIG. 4 through the third compensation wheel end rotation angle obtained at block 604.

FIG. 7 illustrates a schematic block diagram of an example control module 700 for controlling traveling of a vehicle on a bend in the vehicle according to an example of the present disclosure. The control module 700 shown in FIG. 7 may be used for performing the methods and processes shown in FIG. 2 to FIG. 6, e.g., the control module 700 may be an ADAS (advanced driving assistance system) module, a PID (scale-integral-divide) module, or an LQR (linear secondary regulator) module of a vehicle. As shown in FIG. 7, the control module 700 may comprise a sensor module 710, a driving mode module 720, and a feedforward and feedback module 730. The sensor module 710 may comprise a camera and other sensors for detecting road information for the bend and a current speed of the vehicle (and current position and current orientation), etc.

The driving mode module 720 may comprise a customary wheel end rotation angle determination module 722 and a theoretical wheel end rotation angle determination module 724. The customary wheel end rotation angle determination module 722 may determine a customary wheel end rotation angle based on a mapping table of “speed, radius of curvature, and customary wheel end rotation angle” by, for example, a radius of curvature and a current speed obtained from the sensor module 710. The theoretical wheel end rotation angle determination module 724 may determine a theoretical wheel end rotation angle based, for example, on a pre-stored mapping table of mapping relationships between “speed, radius of curvature, and theoretical wheel end rotation angle” by a radius of curvature and a current speed obtained from the sensor module 710. Further, it should be understood that the theoretical wheel end rotation angle determination module 724 may also calculate a corresponding theoretical wheel end rotation angle based on data detected by the sensor module 710 and vehicle parameters of the vehicle, etc.

The feedforward and feedback module 730 may comprise a feedforward module (FFW-Adapter) 732 and a feedback module (Feed-Adapter) 734. The feedforward module 732 may receive, for example, a customary wheel end rotation angle and a theoretical wheel end rotation angle from the driving mode module 720 and determine a wheel end rotation angle difference between the customary wheel end rotation angle and the theoretical wheel end rotation angle (corresponding to block 302 of FIG. 3). The feedforward module 732 may also determine whether to control the vehicle using the customary wheel end rotation angle or the theoretical wheel end rotation angle (corresponding to blocks 304-308 of FIG. 3) based on whether the wheel end rotation angle difference is less than or equal to a predetermined threshold.

Further, in some examples, in case that it is determined that the customary wheel end rotation angle is used for controlling the vehicle, the feedforward module 732 may also adjust the wheel end rotation angle of the vehicle to the customary wheel end rotation angle (corresponding to block 402 of FIG. 4) and transmit the wheel end rotation angle difference to the feedback module 734. The feedback module 734 may determine a compensation wheel end rotation angle (corresponding to block 404 of FIG. 4 and blocks 502 and 504 of FIG. 5) for correcting a traveling error of the vehicle based on the wheel end rotation angle difference and the original predetermined turn route (e.g., the center line of the bend).

Further, in some other examples, the feedforward module 732 may adjust the wheel end rotation angle of the vehicle to the customary wheel end rotation angle (corresponding to block 402 of FIG. 4) and determine an actual turn route based on the radius of curvature of the bend and the current speed of the vehicle detected by the sensor module 710, as well as the customary wheel end rotation angle obtained by the driving mode module 720 (corresponding to block 602 of FIG. 6). In this instance, in some examples, the feedback module 734 may determine the compensation wheel end rotation angle (corresponding to block 404 of FIG. 4 and block 604 of FIG. 6) for correcting a traveling error of the vehicle by tracking the actual turn route.

The wheel end rotation angle values for controlling the vehicle as determined above may be output to respective execution components of the vehicle to complete controlling of the vehicle. Through the control module 700 above, the method according to the examples of the present disclosure is capable of controlling traveling of the vehicle on the bend according to the current traveling information and the historical traveling information of the vehicle, thereby improving the controlling consistency of traveling of the vehicle on the bend and making the traveling of the vehicle more consistent with user habits, so as to improve user experience.

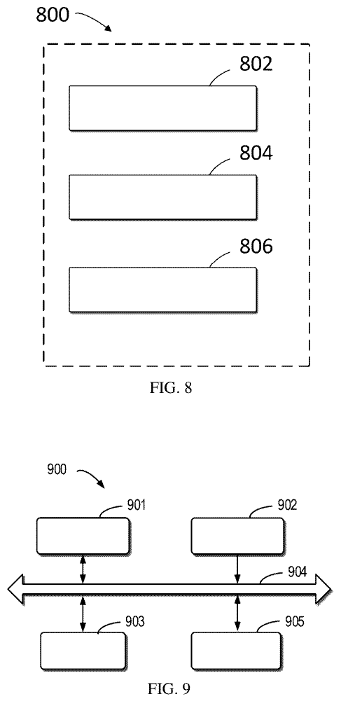

FIG. 8 illustrates a schematic block diagram of a device for controlling traveling of a vehicle on a bend according to an example of the present disclosure. As shown in FIG. 8, the device 800 comprises a road information obtaining unit 802 configured to obtain road information of the bend in response to detecting that the vehicle is located on the bend. The device 800 also comprises a vehicle traveling information obtaining unit 804 configured to obtain vehicle traveling information for the bend, the vehicle traveling information comprising current traveling information and historical traveling information. The device 800 also comprises a turn control unit 806 configured to control traveling of the vehicle on the bend through road information and vehicle traveling information.

In some examples, the road information may comprise a radius of curvature of the bend. In some examples, the current traveling information may comprise a current speed of the vehicle. In some examples, the current traveling information may comprise a theoretical turn angle for the current speed and the radius of curvature. In some examples, the historical traveling information may comprise a customary turn angle for the current speed and the radius of curvature. In some examples, the theoretical turn angle may correspond to a theoretical wheel end rotation angle for traveling a vehicle along a predetermined turn route with the predetermined traveling control function enabled. In some examples, the customary turn angle may correspond to a customary wheel end rotation angle of the vehicle with the predetermined traveling control function disenabled.

In some examples, the device may also comprise a customary wheel end rotation angle obtaining unit configured to obtain a customary wheel end rotation angle through all historical wheel end rotation angles. In some other examples, the customary wheel end rotation angle obtaining unit may be configured to obtain the customary wheel end rotation angle through a most recent predetermined number of historical wheel end rotation angles. In yet other examples, the customary wheel end rotation angle obtaining unit may be configured to obtain the customary wheel end rotation angle through historical wheel end rotation angles within the most recent predetermined period of time. In some examples, the historical wheel end rotation angle may represent the wheel end rotation angle of the vehicle traveling on the bend with the radius of curvature at a current speed in case that the predetermined traveling control function is not enabled prior to current time.

In some examples, the turn control unit 806 may also be configured to determine a wheel end rotation angle difference between a customary wheel end rotation angle and a theoretical wheel end rotation angle. In some examples, the turn control unit 806 may also be configured to control traveling of the vehicle on the bend using a customary wheel end rotation angle in response to the wheel end rotation angle difference being less than or equal to a predetermined threshold. In some examples, the turn control unit 806 may also be configured to control traveling of the vehicle on the bend using the theoretical wheel end rotation angle in response to the wheel end rotation angle difference being greater than a predetermined threshold.

In some examples, the turn control unit 806 may also be configured to adjust the wheel end rotation angle of the vehicle to a customary wheel end rotation angle. In some examples, the turn control unit 806 may also be configured to determine a compensation wheel end rotation angle through the current position and the current orientation of the vehicle during traveling of the vehicle. In some examples, the compensation wheel end rotation angle is used for correcting a traveling error of the vehicle during traveling. In some examples, the turn control unit 806 may also be configured to adjust the current wheel end rotation angle of the vehicle through the compensation wheel end rotation angle to control traveling of the vehicle on the bend.

In some examples, the turn control unit 806 may also be configured to determine a first compensation wheel end rotation angle for adjusting the vehicle to a predetermined turn route through the current position and the current orientation of the vehicle. In some examples, the turn control unit 806 may also be configured to obtain a second compensation wheel end rotation angle by adjusting the first compensation wheel end rotation angle through the wheel end rotation angle difference. In this instance, in some examples, the turn control unit 806 may also be configured to adjust the current wheel end rotation angle through the second compensation wheel end rotation angle.

In some other examples, the turn control unit 806 may also be configured to determine an actual turn route for causing the vehicle to travel on the bend by a radius of curvature, a current speed, and a customary wheel end rotation angle. In some examples, the turn control unit 806 may also be configured to determine a third compensation wheel end rotation angle for adjusting the vehicle to the actual turn route through the current position and the current orientation of the vehicle. In this instance, in some examples, the turn control unit 806 may also be configured to adjust the current wheel end rotation angle of the vehicle through the third compensation wheel end rotation angle.

The device 800 according to the examples of the present disclosure is capable of controlling traveling of the vehicle on the bend according to the current traveling information and the historical traveling information of the vehicle, thereby improving the controlling consistency of traveling of the vehicle on the bend and making the traveling of the vehicle more consistent with user habits, so as to improve user experience.

FIG. 9 illustrates a schematic block diagram of an exemplary device 900 suitable for implementing the examples of the present disclosure. The above-mentioned controller can be implemented using the device 900. As shown, the device 900 comprises a processor 901, which can perform various appropriate actions and processes according to computer program instructions stored in a read-only memory (ROM) 902 and loaded into a random-access memory (RAM) 903. Various programs and data required for the operation of the device 900 may also be stored in the RAM 903. The processor 901, the ROM 902, and the RAM 903 are interconnected through a bus 904. An input/output (I/O) interface 905 is also connected to the bus 904.

The various processes and processing described above, such as the method 200 and the processes 300, 400, 500 and 600 may be executed by the processor 901. For example, in some examples, the method 200 and the processes 300, 400, 500 and 600 can be implemented as a computer software program tangibly contained in a machine-readable medium. In some examples, part or all of the computer programs may be loaded and/or installed onto the device 900 through the ROM 902. When the computer program is loaded onto the RAM 903 and executed by the processor 901, one or more actions of the method 200 and the processes 300, 400, 500 and 600 described above may be performed.

The present disclosure may be a method, device, system and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: a portable computer disk, a hard disk, a random access memory (RAM), a read-only memory (ROM), an erasable programmable read-only memory (EPROM or flash), a static random access memory (SRAM), a portable compact disc read-only memory (CD-ROM), a digital versatile disc (DVD), a memory stick, a floppy disk, or a mechanical coder, such as a punch card with instructions or structures with protrusions in grooves or indentations, as well as any suitable combinations of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

What is claimed is:

1. A method for controlling traveling of a vehicle on a bend, comprising:
obtaining road information of the bend in response to detecting that the vehicle is located on the bend;
obtaining vehicle traveling information for the bend, the vehicle traveling information comprising current traveling information and historical traveling information; and
controlling traveling of the vehicle on the bend through the road information and the vehicle traveling information.

2. The method according to claim 1, wherein the road information comprises a radius of curvature of the bend, and
wherein the current traveling information comprises: at least one of a current speed of the vehicle and a theoretical turn angle for the current speed and the radius of curvature,
wherein the historical traveling information comprises: a customary turn angle for the current speed and the radius of curvature.

3. The method according to claim 2, wherein the theoretical turn angle corresponds to a theoretical wheel end rotation angle for enabling the vehicle to travel along a predetermined turn route in case that a predetermined traveling control function is enabled, and
wherein the customary turn angle corresponds to a customary wheel end rotation angle of the vehicle in case that the predetermined traveling control function is not enabled.

4. The method according to claim 3, wherein controlling traveling of the vehicle on the bend through the road information and the vehicle traveling information comprises:
determining a wheel end rotation angle difference between the customary wheel end rotation angle and the theoretical wheel end rotation angle;
controlling traveling of the vehicle on the bend using the customary wheel end rotation angle in response to the wheel end rotation angle difference being less than or equal to a predetermined threshold; and
controlling traveling of the vehicle on the bend using the theoretical wheel end rotation angle in response to the wheel end rotation angle difference being greater than the predetermined threshold.

5. The method according to claim 4, wherein controlling traveling of the vehicle on the bend using the customary wheel end rotation angle comprises:
adjusting a wheel end rotation angle of the vehicle to the customary wheel end rotation angle;
determining a compensation wheel end rotation angle through a current position and a current orientation of the vehicle during traveling of the vehicle, the compensation wheel end rotation angle being used for correcting a traveling error of the vehicle during traveling; and
adjusting a current wheel end rotation angle of the vehicle through the compensation wheel end rotation angle to control traveling of the vehicle on the bend.

6. The method according to claim 5, wherein determining the compensation wheel end rotation angle through the current position and the current orientation of the vehicle comprises:
determining a first compensation wheel end rotation angle for adjusting the vehicle to the predetermined turn route through the current position and the current orientation of the vehicle; and
adjusting the first compensation wheel end rotation angle through the wheel end rotation angle difference to obtain a second compensation wheel end rotation angle,
wherein adjusting the current wheel end rotation angle of the vehicle through the compensation wheel end rotation angle comprises: adjusting the current wheel end rotation angle through the second compensation wheel end rotation angle.

7. The method according to claim 5, wherein determining the compensation wheel end rotation angle through the current position and the current orientation of the vehicle comprises:
determining an actual turn route for traveling of the vehicle on the bend through the radius of curvature, the current speed, and the customary wheel end rotation angle; and
determining a third compensation wheel end rotation angle for adjusting the vehicle to the actual turn route through the current position and the current orientation of the vehicle,
wherein adjusting the current wheel end rotation angle of the vehicle through the compensation wheel end rotation angle comprises: adjusting the current wheel end rotation angle through the third compensation wheel end rotation angle.

8. The method according to claim 2, further comprising one of:
obtaining the customary wheel end rotation angle through all historical wheel end rotation angles;
obtaining the customary wheel end rotation angle through a most recent predetermined number of the historical wheel end rotation angles; and
obtaining the customary wheel end rotation angle through the historical wheel end rotation angles within a most recent predetermined period of time,
wherein the historical wheel end rotation angle represents a wheel end rotation angle of the vehicle traveling on the bend with the radius of curvature at the current speed in case that the predetermined traveling control function is not enabled prior to current time.

9. A device for controlling traveling of a vehicle on a bend, comprising:
a road information obtaining unit configured to obtain road information of the bend in response to detecting that the vehicle is located on the bend;
a vehicle traveling information obtaining unit configured to obtain vehicle traveling information for the bend, the vehicle traveling information comprising current traveling information and historical traveling information; and
a turn control unit configured to control traveling of the vehicle on the bend through the road information and the vehicle traveling information.

10. A controller, comprising:
at least one processor, and
a memory, coupled to the at least one processor, and having instructions stored thereon that, when executed by the at least one processor, cause the controller to perform the method according to claim 1.

11. A vehicle, comprising the controller according to claim 10.

12. A computer program product, comprising computer-executable instructions, wherein the computer-executable instructions are executed by a processor to implement the method according to claim 1.
